(19) United States
(12) Patent Application Publication
(10) Pub. No.: US 2011/0069089 A1
(43) Pub. Date: Mar. 24, 2011

(54) POWER MANAGEMENT FOR ORGANIC LIGHT-EMITTING DIODE (OLED) DISPLAYS

(75) Inventors: Johannes P. Kopf, Redmond, WA (US); Georg F. Petschnigg, Seattle, WA (US); Michael F. Cohen, Seattle, WA (US)

(73) Assignee: MICROSOFT CORPORATION, Redmond, WA (US)

(21) Appl. No.: 12/610,834

(22) Filed: Nov. 2, 2009

Related U.S. Application Data
(60) Provisional application No. 61/245,271, filed on Sep. 23, 2009.

(51) Int. Cl. G09G 5/10; G09G 5/00; G09G 3/30

(52) U.S. Cl. 345/690; 345/211; 345/77

(57) ABSTRACT

Embodiments of power management for OLED displays are described. In various embodiments, power consumption for an OLED display can be managed by adjusting brightness of individual pixels. An input image can be obtained and processed using an algorithm that reduces brightness and maintains perceived contrast. This can involve computing a difference value associated with individual pixels of the image to account for perceived contrast and computing a reduced brightness value for the pixel using the difference value. An ultra-low power mode in which power consumption of the OLED display is adjusted semantically can be employed for a low brightness range. The algorithm and the ultra-low power mode can be combined to provide a continuous range of adjustment for the OLED display.

### RELATED APPLICATION

This application claims the benefit of a related U.S. Provisional Application Ser. No. 61/245,271 filed Sep. 23, 2009 entitled “Power Management for OLED Displays” to Kopf et al., the disclosure of which is incorporated by reference herein in its entirety.

### BACKGROUND

Computing devices that use organic light-emitting diode (OLED) displays are becoming increasingly more common. For instance, an OLED display can be used as an integrated or external display for a desktop computer. OLED displays can also be integrated with portable devices such as laptop computers, tablet PCs, digital camera devices, mobile phones, ultra-mobile PCs, as well as other mobile data, messaging, and/or communication devices. Users of portable devices continue to seek improvement in the battery life of the portable devices. OLED displays, however, can have individual diodes for each pixel, can be constructed without a backlight, and consume exponentially more power as brightness is increased. Accordingly, managing power for devices that make use of OLED displays can present challenges.

One existing power management approach involves using a mapping of color from a displayed image in an input range to an output range having reduced values. For example color can be mapped from a color range of 0-255 to a color range of 0-128 This approach, however, can result in images that appear dull, include banding, and/or can have undesired effects on contrast of the image. Accordingly, existing approaches to power management of OLED displays can fail to produce images that are acceptable to users of the devices.

### SUMMARY

This summary is provided to introduce simplified concepts of power management for OLED displays. The simplified concepts are further described below in the Detailed Description. This summary is not intended to identify essential features of the claimed subject matter, nor is it intended for use in determining the scope of the claimed subject matter.

Embodiments of power management for OLED displays are described. In various embodiments, power consumption for an OLED display can be managed by adjusting brightness of individual pixels. An input image can be obtained and processed using an algorithm that reduces brightness and maintains perceived contrast. This can involve computing a difference value associated with individual pixels of the image to account for perceived contrast and computing a reduced brightness value for the pixel using the difference value. An ultra-low power mode in which power consumption of the OLED display is adjusted semantically can be employed for a low brightness range. The algorithm and the ultra-low power mode can be combined to provide a continuous range of adjustment for the OLED display.

### BRIEF DESCRIPTION OF THE DRAWINGS

Embodiments of power management for OLED displays are described with reference to the following drawings. The same numbers are used throughout the drawings to reference like features and components:

FIG. 1 illustrates an example of a device that can implement various embodiments of power management for OLED displays.

FIG. 2 illustrates an example system in which embodiments of power management for OLED displays can be implemented.

FIG. 3 illustrates example method(s) for power management for OLED displays in accordance with one or more embodiments.

FIG. 4 illustrates other example method(s) for power management for OLED displays in accordance with one or more embodiments.

FIG. 5 illustrates various components of an example device that can implement embodiments of power management for OLED displays.

### DETAILED DESCRIPTION

Embodiments of power management for OLED displays provide techniques for effective management of power consumption of an OLED display by adjusting the brightness and/or other control variables associated with individual pixels.

For example, an event can occur that initiates power management, such as an input by a user, detection of low battery life, a timing event, and so forth. Responsive to initiation of power management, an input image is obtained upon which processing is performed to reduce power consumption of the image. The image can be a user interface of an application, a video frame, a digital picture, or other suitable image that is output for presentation on the OLED display. Processing of the image can involve application of an algorithm to the image pixel by pixel to reduce brightness and maintain perceived contrast. The algorithm can make use of a difference value calculation to account for perceived contrast. For a low brightness range, an ultra-low power mode can be selectively employed to provide a wide range of brightness adjustment. In this manner, a power-managed image configured to consume less power can be generated for display on the OLED display.

While features and concepts of the described systems and methods for power management for OLED displays can be implemented in any number of different environments, systems, and/or various configurations, embodiments of power management for OLED displays are described in the context of the following example systems and environments.

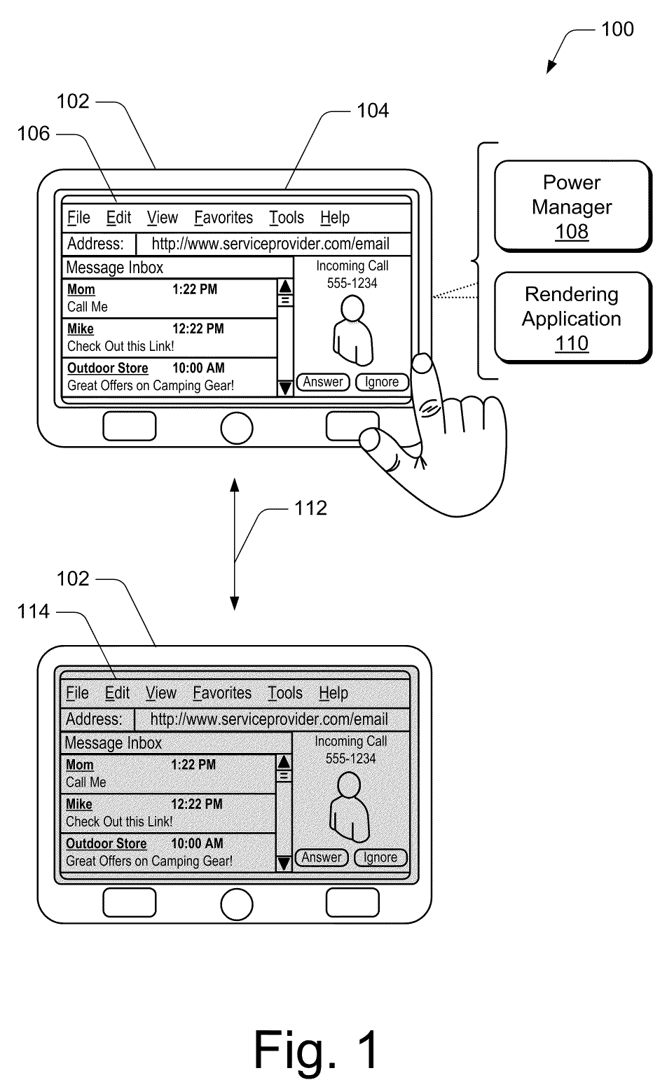

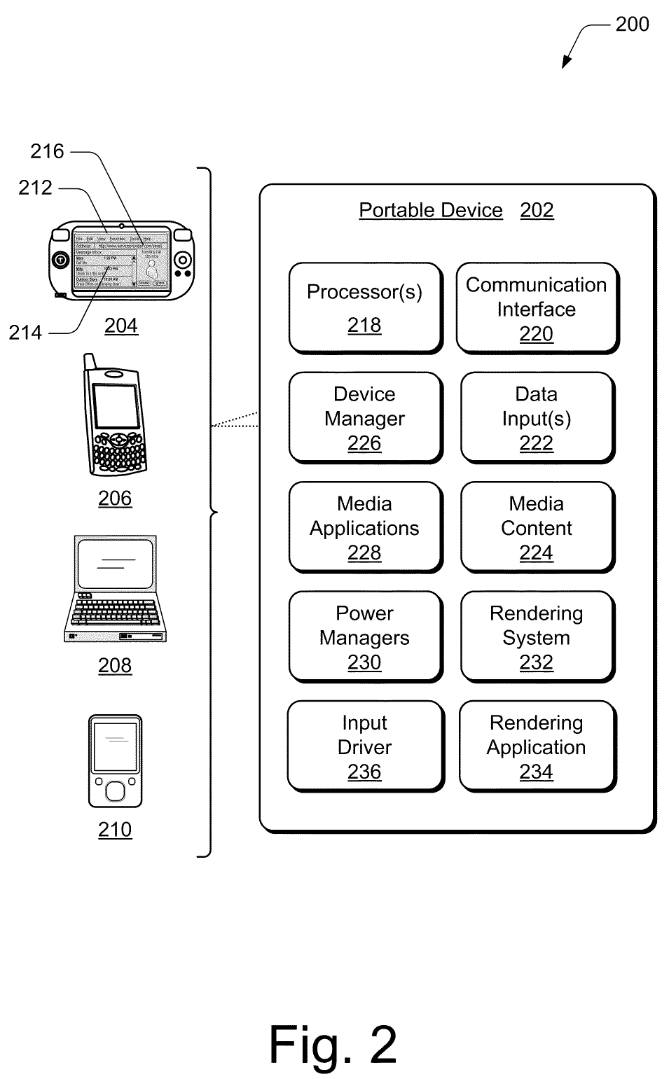

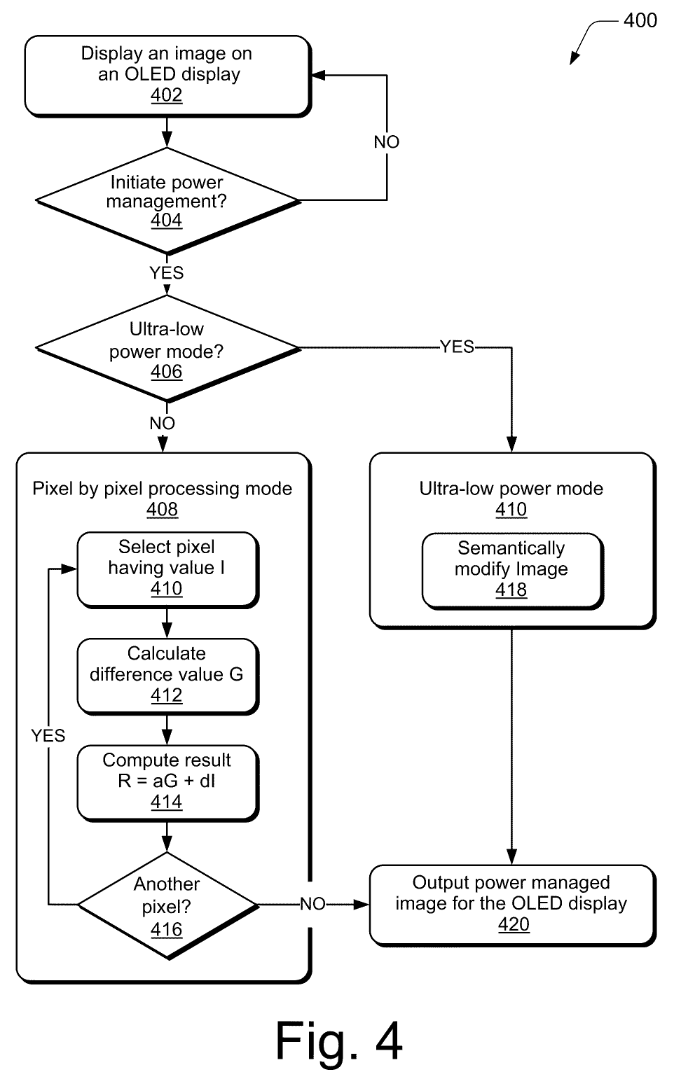

FIG. 1 illustrates an example 100 of a computing device 102 that can implement various embodiments of power management for OLED displays. The computing device 102 is an example of various types of devices including example portable devices described with reference to FIG. 2 and can also be implemented with any number and combination of differing components as described with reference to the example device shown in FIG. 4. The computing device 102 includes an integrated display screen 104 to display user interfaces, user interface elements and features, user-selectable controls, various displayable images and objects, and the like. The display screen 104 can be configured as an OLED display.

Techniques described herein as applicable to OLED displays can also be applied to other types of displays that have similar characteristics. For instance, suitable display screens 104 enable at least adjustment of brightness on an individual pixel basis. The computing device 102 also includes an image 106 that is presented on the display screen 104. The image 106 is an example of various types of images that can appear on the display screen 104 including user interfaces, digital pictures, movies and other video presentations, game interfaces, documents, scanned images, etc.

The computing device 102 further includes at least a power manager 108 to implement power management schemes for the computing device 102 and a rendering application 110 to cause presentation of various images 106 on the display screen 104. The rendering application 110 can be implemented as a standalone component and/or as a component of another device application that performs graphics rendering for the computing device 102. In the depicted example, the image 106 is shown as a browser user interface and the rendering application 110 represents functionality the can be used by the browser to present the user interface on the display screen 104.

Further, the power manager 108 represents functionality of the computing device 102 to implement techniques for power management for OLED displays as described herein. In an embodiment of power management for OLED displays, the power manager 108 can detect various events to initiate power management. For example, power management can be initiated responsive to a user selection to reduce brightness or select a power level, detection of low battery power, a timed event such as a period of inactivity, and a variety of other suitable events.

Responsive to initiation of power management, the power manager 108 is implemented to obtain input images for processing. For instance, the power manager 108 can intercept or otherwise obtain images that are generated by the rendering application 110 for display on the display screen 104. The power manager 108 can process the obtained images in various ways to generate output images that are configured to consume less power than the input images.

For instance, the power manager 108 can be implemented to apply a power management scheme to the image 106 as represented by the arrow 112 of FIG. 1. The power management scheme can enable adjustments through a wide range of brightness values. As described below, the power manager 108 can implement the power management scheme to selectively switch between multiple power management modes. Application of the power management scheme can result in a power-managed image 114 that is configured to consume less power than the image 106. The power manager 108, alone or with the aid of the rendering application 110, can further cause the power-managed image 114 to be output for presentation on the display screen 104 as depicted in FIG. 1.

Application of the power management scheme by the power manager 108 can include at least a normal mode (e.g., un-managed mode), a pixel by pixel processing mode, and/or an ultra-low power mode. The power manager 108 can be configured to manage and selectively switch between various modes to implement power management for the computing device 102. To selectively switch between modes, power manager 108 can be configured to balance criteria including brightness level, amount of power reduction, contrast levels, battery life remaining, and so forth. Employing the various modes enables adjustments to achieve a wide range of brightness and corresponding power consumption levels. The modes can be selected by the power manager 108 automatically and/or in conjunction with input from a user to select a mode. The power manager 108 can make use of the various modes individually and/or in various combinations to implement a power management scheme for a computing device 102.

In the normal mode, images output for display on the display screen 104 are presented without processing the images to reduce power consumption. The power manager 108 can then be implemented to monitor for and detect events that trigger a switch from the normal mode to other modes.

Pixel by pixel processing mode can take advantage of the capabilities of OLED displays and/or other similar display screens 104 to achieve a reduction in power consumption by reducing brightness of pixels individually. In accordance with techniques described herein, the power manager 108 can derive a brightness reduction factor for individual pixels of an input image. The power manager 108 can further modify the brightness reduction factor for a given pixel with a contrast preservation factor that accounts for perceived contrast. In this way, the power manager 108 can maintain perceived contrast while reducing power consumption. Perceived contrast refers to the localized effect that a surrounding region has on viewer perception of brightness and contrast of objects within the region. For example, an object or pixel surrounded by a dark region is perceived brighter than the same object or pixel when it is surrounded by a relatively brighter region. Approaches that simply manage power for a device using a constant reduction in power/brightness fail to account for and preserve the localized contrast in an image.

In at least some embodiments, the power manager 108 can make use of any suitable algorithm that accounts for perceived contrast. Generally, power manager 108 can determine a power reduction value and calculate a brightness reduction factor to achieve the power reduction value. To account for local contrast, the power manager can calculate a contrast preservation factor. The contrast preservation factor can be combined with the brightness reduction factor in any suitable way to produce output brightness values for a power-managed image.

In an implementation, the power manager 108 can use an algorithm to compute a difference value associated with individual pixels of an input image to account for perceived contrast. The difference value can be computed as the difference between an input image and a low-pass filtered version of the image. One example algorithm that can be employed to implement power management for OLED displays is as follows:

R=a*G+d*I,

where:
R=result for power-managed image
a=preservation coefficient
d=reduction coefficient
I=input value for image (e.g., brightness, luminosity, intensity, color, voltage, etc.).
G=difference value computed as I-I′ where I′ is a low-pass filtered version of I.

The power manager 108 can apply the above algorithm pixel by pixel to an input image that is obtained for processing. In particular, given the input image, for each pixel of the input image, a value R is computed using the difference value G and the input value I. The input value I may represent a value for brightness, luminosity, intensity, color, voltage, or other suitable control variables associated with a particular pixel of the image that can be adjusted to control power consumption. The input value I is multiplied by the reduction coefficient d to obtain a brightness reduction factor d*I. The computed difference value G for a given pixel is multiplied by the reduction coefficient a to obtain a contrast preservation factor a*G. The result R for each pixel is computed as the sum of the brightness reduction factor d*I and the contrast preservation factor a*G.

In an implementation, the coefficients a and d can both be configured between values of 0 and 1 to obtain a target power consumption level and to enable adjustments of the level of contrast preserved through application of the algorithm. Power consumption for OLED displays generally rises exponentially (e.g., quadratically) with brightness. Accordingly, setting the reduction coefficient d to a value of 0.5 (e.g., half brightness) can reduce power consumption of a display screen to about 25% of power consumption at full brightness.

Although the coefficient d can be varied from 0 to 1, resulting images for values of d under about 0.5 can begin to appear quite dark. Optionally, power manager 108 can be configured to combine the pixel by pixel processing mode as just described with the ultra-low power mode described herein. For instance, power manager 108 can be configured to switch to the ultra-low power mode based upon a target power consumption level and/or a set value for the reduction coefficient d, such as for values of d below about 0.5. Power manager 108 can also be configured to make use of the ultra-low power mode independently responsive to user input, detection of low battery power, and so forth.

In ultra-low power mode, the power manager 108 can be configured to modify an input image on a semantic-level to achieve a reduction in power consumption for a device 102. Semantic-level mapping refers to mapping of different power management modifications based upon different distinct components that can be contained in an input image such as objects, elements, and/or other distinctly defined components of images. In general, a semantic-level mapping can be employed to define components and corresponding attributes of the components and to relate different modifications to different components. The semantic-level mapping can enable power savings by selectively designating modifications to make some components appear bright and others appear dark. In an implementation, a semantic-based power saving map can explicitly assign brighter value colors to some screen elements (e.g., designated or important screen elements) and darker value colors to other screen elements (e.g., designated or less important screen elements). In an implementation, semantic mapping utilizes attributes that are stored in an Document Object Model and or generated from a System Graphics API. For example, with Web pages, the HTML DOM stores object information for each element it displays, and the HTML tags directly identify background, text, line, and/or shape information. Similar HTML DOMs exist for documents, presentations, spreadsheets, books, and other types of content. An example semantic-level mapping is provided below in Table 1.

For example, the ultra-low power mode can employ a semantic-level mapping that is configured to define various element types for the images (e.g., line, image, text, shape, background, etc.), attributes of the element types that can be used to identify the elements, and power management modifications for the different element types. A variety of power management modifications for elements can be designated by the mapping including modifications to set an element to white, set an element to dark, invert color, reduce an input value (e.g., brightness or other control variable) by 50%, reverse polarity, and so on. Of course multiple mappings can be defined for different situations.

In an embodiment, the ultra-low power mode can operate by globally reversing the polarity of the display screen 104 so that dark elements become light and light elements become dark. This reverse polarity technique is well suited for situations such as document and/or electronic book reading where in normal mode, text appears dark and background elements appear light. Reversing polarity in such situations can reduce power consumption and can also improve readability.

Accordingly, the power manager 108 can be configured to implement the ultra-low power mode element by element rather that pixel by pixel. In particular, the power manager 108 can be configured to indentify elements using the defined attributes, use the mapping to determine modification designated for various element types, and apply the determined modifications to produce a power-managed image 114. A representative example of a semantic level mapping that is suitable to implement an ultra-low power mode for power management of OLED displays appears in the following table.

TABLE 1
Example Semantic Level Mapping

| Element | Attributes | Modification |
|---|---|---|
| Background | Low color variation | Set color to Black |
| | No match to other | |
| | element | |
| Text | Detected by OCR | Set color to 50% |
| | Editable | White |
| Image | Image reference | Darken 50% |
| | Framed | |
| Line | Fits y = mx + b | Darken 50% |
| | Detected as edge | |

FIG. 2 illustrates an example system 200 in which various embodiments of power management for OLED displays can be implemented. Example system 200 includes a portable device 202 (e.g., a wired and/or wireless device) that can be any one or combination of a mobile personal computer 204, a personal digital assistant (PDA), a mobile phone 206 (e.g., cellular, VoIP, WiFi, etc.) that is implemented for data, messaging, and/or voice communications, a portable computer device 208 (e.g., a laptop computer, a laptop computer with a touch-screen, etc.), a media device 210 (e.g., a personal media player, portable media player, etc.), a gaming device, an appliance device, an electronic device, and/or any other type of portable device that can receive, display, and/or communicate data in any form of audio, video, and/or image data.

Each of the various portable devices can include an integrated OLED display and/or an integrated touch-screen or other display, as well as selectable input controls via which a user can input data and/or selections. For example, mobile personal computer 204 includes an integrated OLED screen 212 on which a user interface 214 can be displayed that includes displayable objects and/or user interface elements 216, such as any type of image, graphic, text, selectable button, user-selectable control, menu selection, map element, and/or any other type of displayable user interface, image, document, or object.

Any of the various portable devices described herein can be implemented with one or more sensors, processors, communication components, data inputs, memory components, storage media, processing and control circuits, and/or a content rendering system. Any of the portable devices can also be implemented for communication via communication networks that can include any type of a data network, voice network, broadcast network, an IP-based network, and/or a wireless network that facilitates data, messaging, and/or voice communications. A portable device can also be implemented with any number and combination of differing components as described with reference to the example device shown in FIG. 4. A portable device may also be associated with a user (i.e., a person) and/or an entity that operates the device such that a portable device describes logical devices that include users, software, and/or a combination of devices.

In this example, portable device 202 includes one or more processors 218 (e.g., any of microprocessors, controllers, and the like), a communication interface 220 for data, messaging, and/or voice communications, and data inputs 222 to receive media content 224. Media content (e.g., to include recorded media content) can include any type of audio, video, and/or image data received from any media content or data source, such as messages, television media content, music, video clips, data feeds, interactive games, network-based applications, and any other content. Portable device 202 is implemented with a device manager 226 that includes any one or combination of a control application, software application, signal processing and control module, code that is native to the particular device, and/or a hardware abstraction layer for the particular device.

Portable device 202 includes various software and/or media applications 228 that may incorporate components such as power managers 230 that can be processed or otherwise executed by the processors 218. The media applications 228 can include a music and/or video player, a Web browser, an email application, a messaging application, a digital photo application, and the like. Portable device 202 includes a rendering system 232 to render images from various applications of the portable device 202 to generate a display on any of the portable devices. The rendering system 232 is also implemented to receive and render any form of audio, video, and/or image data received from any media content and/or data source. Rendering system 232 can include or otherwise make use of a rendering application 234 to interface with applications, and perform and manage graphic rendering of images for the applications. Implementations of a power manager 230 and rendering application 234 are described with reference to the power manager 108 and rendering application 110 shown in FIG. 1, and with reference to embodiments of power management for OLED displays as described herein.

Portable device 202 also includes an input driver 236 that can incorporate or otherwise make use of a touch-screen driver for the touch-screen 212. The input driver 236 can be configured to detect and process various inputs and/or determinable representations of gestures, inputs, and/or motions to operate functionality of the portable device 202, including operation of a power manager 230 to implement power management for OLED displays.

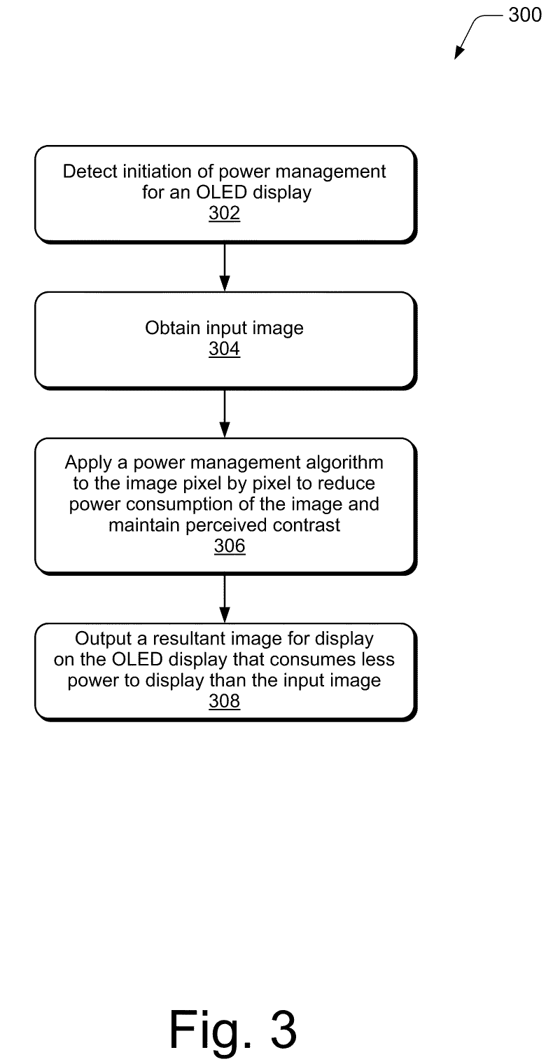

Example methods 300 and 400 are described with reference to respective FIGS. 3 and 4 in accordance with one or more embodiments of power management for OLED displays. Generally, any of the functions, methods, procedures, components, and modules described herein can be implemented using hardware, software, firmware, fixed logic circuitry, manual processing, or any combination thereof A software implementation represents program code that performs specified tasks when executed by a computer processor. The example methods may be described in the general context of computer-executable instructions, which can include software, applications, routines, programs, objects, components, data structures, procedures, modules, functions, and the like. The methods may also be practiced in a distributed computing environment by processing devices that are linked through a communication network. In a distributed computing environment, computer-executable instructions may be located in both local and remote computer storage media and/or devices. Further, the features described herein are platform-independent and can be implemented on a variety of computing platforms having a variety of processors.

FIG. 3 illustrates example method(s) 300 of power management for OLED displays. The order in which the method is described is not intended to be construed as a limitation, and any number of the described method blocks can be combined in any order to implement the method, or an alternate method.

At block 302, initiation of power management for an OLED display is detected. For example, the power manager 108 at computing device 102 can detects various events that initiate power management for an image to display on an OLED display. Detectable events can include user input, a low power state, a mode selection, a timed event, or another suitable event.

At block 304, an input image is obtained for processing. For example, the power manager 108 can interact with a rendering application 110 at the computing device 102 to intercept an image that is being rendered for display on display screen 104. The rendering application 110 can also be configured to communicate images to the power manager 108 for power management processing.

At block 306, a power management algorithm is applied pixel by pixel to the image to reduce power consumption of the image and maintain perceived contrast. For instance, a power manager at a computing device 102 can be configured to employ various suitable techniques to reduce power consumption of an image, including the techniques and algorithms discussed above in relation to the example computing device 102 of FIG. 1. Further examples regarding application of a pixel by pixel power management algorithm can be found below with reference to example method(s) 400 shown in FIG. 4.

At block 308, a resultant image configured to consume less power when displayed is output for display on the OLED display. For example, the power manager 108 at the computing device 102 can cause a power-managed image 114 to be presented via a display screen 104, and the power-managed image 114 is displayed with less power consumption than the input image.

FIG. 4 illustrates example method(s) 400 of power management for OLED displays. The order in which the method is described is not intended to be construed as a limitation, and any number of the described method blocks can be combined in any order to implement the method, or an alternate method.

At block 402, an image is displayed on an OLED display. For instance, a computing device 102 can display the example image 106 of a browser user interface in FIG. 1 on the display screen 104 using a normal mode for power management. At block 404 a determination is made regarding whether power management has been initiated. If power management has not been initiated, the computing device 102 can continue to display the image 106 in the normal mode.

If power management is initiated, at block 406 a determination is made regarding whether to execute ultra-low power mode. Based on this determination, either pixel by pixel processing mode can be executed at block 408 or ultra-low power mode can be executed at block 410.

In the pixel by pixel processing mode of block 408, processing can occur for each pixel of an input image to derive output values for a power-managed image. In particular at block 410, a pixel is selected that is associated with an input value I. The value I can represent brightness or another suitable control variable used to adjust power consumption such as color, intensity, voltage, and so forth. At block 412, a difference value is calculated for the selected pixel. In an implementation, the difference value can be computed using a relatively wide portion of the display, such as computing the difference value for a pixel relative to about one sixth or more of the width of the OLED display. At block 414, a resultant value R corresponding to the input value I is computed according to the formula R=aG+dI as described in relation to the example computing device 102 of FIG. 1.

At block 416 a determination is made regarding whether another pixel of the input image exists for processing. If another pixel exists, the method returns to block 410 and the processing described in relation to blocks 410 to 416 can be repeated for the other pixel. Thus, the processing of selected pixels can continue to occur until it is determined at block 416 that there are no additional pixels to be processed. It should be noted that multiple pixels of the input image can be processed successively and/or concurrently using one or more processors and/or processing threads of a computing device 102.

In ultra-low power mode of block 410, processing can occur for an input image using semantic-level mapping as described previously herein. In particular, at block 418, the input image is semantically modified to produce a power-managed image 114. In at least some embodiments, the polarity of the OLED display is reversed in the ultra-low power mode. In this way, power consumption is reduced by causing dark elements of the input image to appear lighter and light elements to appear darker.

Additionally or alternatively, the semantic modification can involve mapping elements of the input image to corresponding modifications designated by the semantic-level mapping. In particular, the power manager 108 of a computing device 102 can indentify elements in an image using attributes for the elements defined in the mapping. The power manager 108 can then reference the mapping to determine modifications that are designated for various element types. The power manager 108 can further operate to apply the determined modifications to produce a power-managed image 114.

The example method 400 proceeds to block 420 both when no additional pixels are found for processing at block 416 and following the semantic modifications of an image per block 418. At block 420, a power-managed image is output for display via the OLED display. For instance, a computing device 102 can display the power-managed image 114 of the browser user interface on the display screen 104 as depicted in FIG. 1. In this example, the browser user interface can be produced using either or both of a pixel by pixel mode or an ultra-low power mode as described herein. Further, a power manager 108 can be configured to toggle back and forth between the modes in different scenarios.

For example, when a low battery state is detected the pixel by pixel mode can be employed to produce and output a power-managed image 114. When the battery power is further depleted, the ultra-low power mode can then be initiated to produce and output another corresponding power-managed image 114 that consumes even less power. The example method 400 of FIG. 4 just described illustrates an example in which a pixel by pixel mode and an ultra-low power mode are used in combination. It is to be noted that each of the described modes can also be implemented independently by a power manager 108.

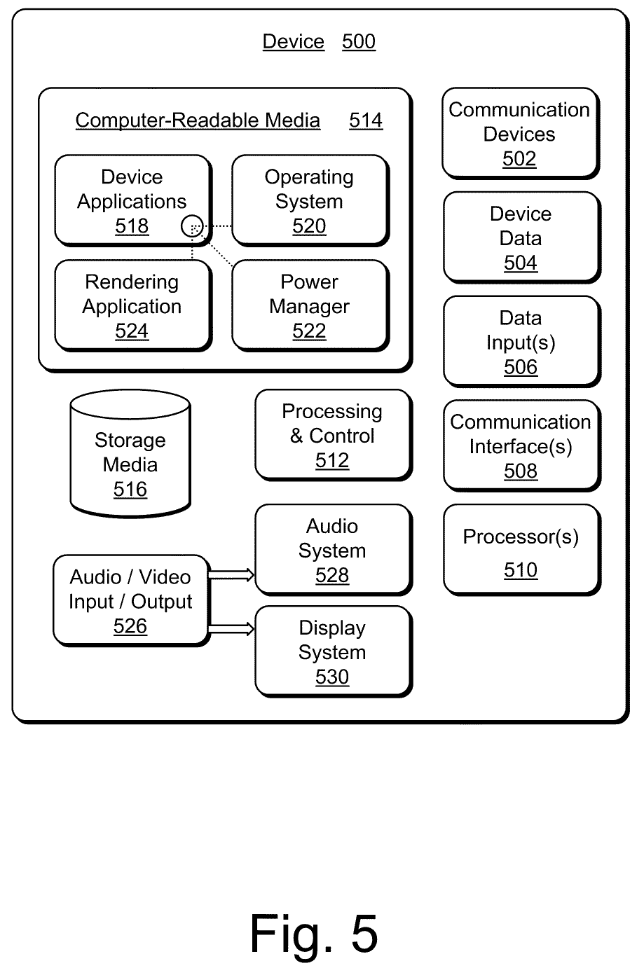

FIG. 5 illustrates various components of an example device 500 that can be implemented as any type of portable and/or computer device as described with reference to FIGS. 1 and 2 to implement embodiments of power management for OLED displays. Device 500 includes communication devices 502 that enable wired and/or wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image data. Device 500 includes one or more data inputs 506 via which any type of data, media content, and/or inputs can be received, such as user-selectable inputs, messages, music, television media content, recorded video content, and any other type of audio, video, and/or image data received from any content and/or data source.

Device 500 also includes communication interfaces 508 that can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices communicate data with device 500.

Device 500 includes one or more processors 510 (e.g., any of microprocessors, controllers, and the like) which process various computer-executable instructions to control the operation of device 500 and to implement embodiments of power management for OLED displays. Alternatively or in addition, device 500 can be implemented with any one or combination of hardware, firmware, or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 also includes computer-readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 516.

Computer-readable media 514 provides data storage mechanisms to store the device data 504, as well as various device applications 518 and any other types of information and/or data related to operational aspects of device 500. For example, an operating system 520 can be maintained as a computer application with the computer-readable media 514 and executed on processors 510. The device applications 518 can include a device manager (e.g., a control application, software application, signal processing and control module, code that is native to a particular device, a hardware abstraction layer for a particular device, etc.). The device applications 518 also include any system components or modules to implement embodiments of power management for OLED displays. In this example, the device applications 518 include a power manager 522 and rendering application 524 that are shown as software modules and/or computer applications. Alternatively or in addition, the power manager 522 and the rendering application 524 can be implemented as hardware, software, firmware, or any combination thereof

Device 500 also includes an audio and/or video input-output system 526 that provides audio data to an audio system 528 and/or provides video data to a display system 530. The audio system 528 and/or the display system 530 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link In an embodiment, the audio system 528 and/or the display system 530 are implemented as external components to device 500. Alternatively, the audio system 528 and/or the display system 530 are implemented as integrated components of example device 500.

Although embodiments of power management for OLED displays have been described in language specific to features and/or methods, it is to be understood that the subject of the appended claims is not necessarily limited to the specific features or methods described. Rather, the specific features and methods are disclosed as example implementations of power management for OLED displays.

1. A method implemented by a computing device, the method comprising:
detecting initiation of power management for a display screen of the computing device;
obtaining an input image for processing responsive to the detecting; and
applying a power management algorithm to the input image pixel by pixel to generate a power-managed image for presentation on the display screen, the power-managed image consuming less power to display than the input image and displayed to maintain perceived contrast of the input image.

2. A method as recited in claim 1, wherein the display screen comprises an organic light emitting diode (OLED) display.

3. A method as recited in claim 1, wherein the input image comprises at least one of a user interface for an application of the computing device, or a frame of a video presentation output for display on the display screen.

4. A method as recited in claim 1, wherein obtaining the input image comprises intercepting the image generated for display on the display screen by a rendering application of the computing device.

5. A method as recited in claim 1, wherein applying the power management algorithm comprises determining a power reduction value and for each pixel of the input image:
calculating a brightness reduction factor to achieve the power reduction value;
calculating a contrast preservation factor to account for the perceived contrast of the input image; and
combining the brightness reduction factor and the contrast preservation factor to obtain an output brightness value of the pixel for the power-managed image.

6. A method as recited in claim 1, wherein applying the power management algorithm comprises, for each pixel:
determining an input value for a control variable associated with the pixel that can be adjusted to control power consumption of the input image; and
adjusting the input value according to the algorithm to obtain an output value of the pixel for the power-managed image.

7. A method as recited in claim 6, wherein the control variable corresponds to brightness of the pixel.

8. A method as recited in claim 6, wherein the control variable corresponds to one of luminosity, intensity, color, or voltage associated with the pixel.

9. A method as recited in claim 1, wherein detecting initiation of power management comprises detecting at least one of a user selection, low battery power, or a timed event.

10. A method as recited in claim 1, further comprising:
detecting initiation of an ultra-low power mode for power management of the display screen; and
executing the ultra-low power mode to semantically modify the input image to generate a corresponding power-managed image.

11. A method as recited in claim 10, wherein semantically modifying the input image comprises configuring the input image according to a semantic-level mapping that designates modifications to apply to the input image based on element types to generate the corresponding power-managed image.

12. A portable computing device, comprising:
an organic light-emitting diode (OLED) display;
one or more processors coupled to memory; and
a power manager stored in the memory and executable via the one or more processors to cause the portable computing device to perform power management for the OLED display by at least:
detecting initiation of power management for the OLED display;
responsive to the detecting, selecting between a pixel by pixel processing mode and an ultra-low power mode to generate a power-managed image from an input image for presentation on the OLED display; and
causing display of the power-managed image on the OLED display.

13. A portable computing device as recited in claim 12, wherein the power manager is configured to generate the power-managed image from the input image to maintain a perceived contrast of the input image.

14. A portable computing device as recited in claim 13, wherein the power manager is further configured to execute the pixel by pixel processing mode, when selected, to generate the power managed image by at least:
determining a power reduction value and for each pixel of the input image:
calculating a brightness reduction factor to achieve the power reduction value;
calculating a contrast preservation factor to account for the perceived contrast of the input image; and
adding the brightness reduction factor and the contrast preservation factor to obtain an output brightness value of the pixel for the power-managed image.

15. A portable computing device as recited in claim 12, wherein the power manager is further configured to execute the ultra-low power mode, when selected, to generate the power-managed image by semantically modifying the input image element by element according to a semantic-level mapping that defines modifications to apply to the input image based on element types.

16. A portable computing device as recited in claim 12, wherein the power manager is further configured to execute the ultra-low power mode, when selected, to generate the power-managed image by reversing polarity of the OLED display.

17. A portable computing device as recited in claim 12, wherein the power manager is further configured to:
determine an input value for a control variable associated with each pixel that can be adjusted to control power consumption of the input image; and
adjust the input value according to a power management algorithm to obtain an output value of each pixel for the power-managed image.

18. A portable computing device as recited in claim 17, wherein the control variable corresponds to at least one of brightness, luminosity, intensity, color, or voltage associated with the pixel.

19. Computer-readable media having stored thereon computer-executable instructions that, if executed by a computing device, initiate the computing device to implement a power management scheme to manage power consumption of an image for presentation on an organic light emitting diode (OLED) display by selectively switching between power management modes including:
a pixel by pixel processing mode configured to generate a power-managed image for presentation on the OLED display from the image by:
determining a power reduction value and for each pixel of the image:
calculating a brightness reduction factor to achieve the power reduction value;
calculating a contrast preservation factor to account for perceived contrast of the input images; and
summing the brightness reduction factor and the contrast preservation factor to obtain an output brightness value of the pixel for the power-managed image; and
generating the power-managed image using the output brightness values obtained for each pixel; and
an ultra-low power mode configured to generate the power-managed image for presentation on the OLED display from the image by:
identifying elements of the image using a semantic-level mapping that defines attributes of the elements and designates different modifications for different element types; and
modifying the identified elements in accordance with the modifications designated by the semantic-level mapping to produce the power-managed image.

20. Computer-readable media as recited in claim 19, wherein the power management modes include a normal mode configured to output the image for presentation on the OLED display without processing the image to reduce power consumption.
